(19) United States
(12) Patent Application Publication
(10) Pub. No.: US 2025/0050930 A1
(43) Pub. Date: Feb. 13, 2025

(54) Remote controlled collapsible and/or non-collapsible utility wagon cart with rechargeable battery

(71) Applicant: Behzad Dabir Panah, New York, NY (US)

(72) Inventor: Behzad Dabir Panah, New York, NY (US)

(21) Appl. No.: 18/333,472

(22) Filed: Aug. 10, 2023

(51) Int. Cl. B62B 5/00; H01M 50/204

(52) U.S. Cl. CPC B62B 5/0043; B62B 5/0053; B62B 5/0076; H01M 50/204; H01M 2220/30

(57) ABSTRACT

This technical disclosure presents a novel and versatile designed to enhance convenience and functionality for shoppers, beachgoers and outdoor enthusiasts transporting heavy items, groceries, tools, equipment etc. The “Remote Controlled Collapsible and Non-Collapsible Utility Wagon & Beach Wagon” integrates advanced features, including a motor, remote control capabilities, rechargeable battery, collapsibility options, and robust utility. The wagon is equipped with a remote control system, allowing users to maneuver it effortlessly across various terrains, such as asphalt, sand, gravel or grass, sidewalks with precision and ease. The remote control offers forward and backward motion, steering control, and variable speed settings, ensuring smooth transportation of beach gear and other essentials. Additionally, the wagon offers collapsibility features for easy storage and transport. Users can fold it down quickly, reducing its size for convenient storage in vehicles or compact spaces. When expanded, it provides a spacious and sturdy cargo area, capable of accommodating groceries, various items, beach chairs, umbrellas, coolers, and more. Constructed from durable materials, this utility beach wagon ensures longevity and reliability even in harsh beach environments. It's rugged wheels, reinforced frame, and corrosion-resistant components make it suitable for extended outdoor use. The Remote Controlled Collapsible and Non-Collapsible Utility Beach Wagon represents a significant advancement in transporting heavy items and equipment due to it being equipped with a motor, rechargeable battery and remote control offering unparalleled convenience and mobility for shoppers, outdoor enthusiasts, making shopping, moving short distances and beach outings more enjoyable and hassle-free.

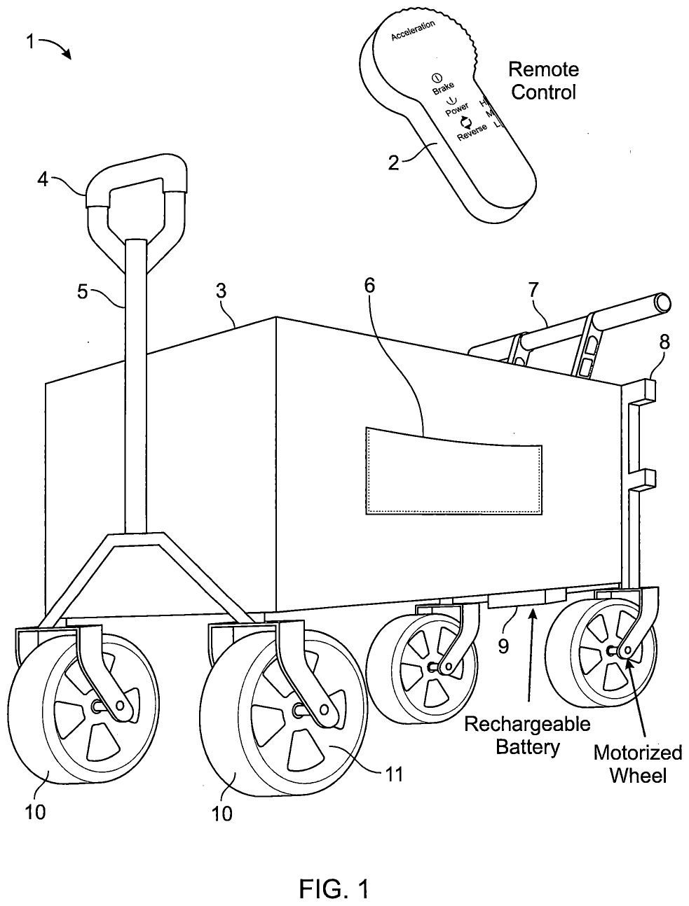

### PATENT CLAIM

A remote-controlled utility beach wagon for carrying heavy items, groceries, and other objects, comprising:
a. A wagon body with a sturdy frame and four wheels for smooth transportation on various terrains, said wagon body equipped with a spacious and versatile storage compartment suitable for accommodating a variety of items.
b. A small motor system integrated into the wagon body, configured to provide motive power to the wheels and enable autonomous movement of the utility beach wagon.
c. A remote control device with appropriate control mechanisms for wirelessly operating and guiding the utility beach wagon.

### PATENT SPECIFICATIONS

### Field of the Invention

The present invention pertains to a remote-controlled utility beach wagon designed to facilitate the transportation of heavy items, groceries, and various belongings in beach and outdoor environments.

The utility beach wagon incorporates a small motor system and a remote control mechanism to enhance convenience and ease of use.

### Background of the Invention

Conventional beach wagons and utility carts are typically manually operated, which can be physically taxing when carrying heavy loads over sandy or uneven terrains. The present invention addresses this challenge by introducing a motorized utility beach wagon with remote control functionality, offering users an effortless and efficient solution for transporting heavy items and groceries.

### DESCRIPTION OF THE INVENTION

The remote-controlled utility beach wagon of this invention is designed to provide a versatile and user-friendly means of carrying heavy items, groceries, and various belongings in beach and outdoor settings. The following detailed description elucidates the key components and functionalities of the invention:

### 1. Wagon Body:

The utility beach wagon features a wagon body with a sturdy frame constructed from durable materials such as metals, composites, or reinforced plastics. The wagon body is designed with four wheels to ensure stable and smooth transportation across various terrains, including sand, grass and pavement. The wheels are preferably equipped with reliable bearings for reduced friction and improved maneuverability.

The wagon body houses a spacious and versatile storage compartment, strategically designed to accommodate a wide range of items, including but not limited to beach chairs, umbrellas, coolers, sporting equipment, groceries, and other personal belongings. The storage compartment may incorporate adjustable dividers or securing mechanisms to organize and secure the transported items effectively.

### 2. Small Motor System:

Integrated into the wagon body is a small and efficient electric motor system responsible for driving the wheels and providing autonomous movement to the utility beach wagon.

The motor system is powered by a rechargeable battery source, positioned within the wagon body to maintain a balanced weight distribution and prevent obstruction of the storage compartment.

The motor system is controlled by an onboard electronic controller, which communicates with the remote control device to execute user commands accurately. The controller regulates the speed and direction of the utility beach wagon, offering smooth acceleration and deceleration for a seamless user experience.

### 3. Remote Control Device:

The remote-controlled utility beach wagon is accompanied by a user-friendly remote control device, featuring intuitive control mechanisms such as joysticks, buttons, or touch-sensitive surfaces.

The remote control enables users to wirelessly operate and maneuver the utility beach wagon from a distance, enhancing convenience and user control.

The remote control device communicates with the electronic controller within the utility beach wagon through wireless communication protocols, ensuring real-time and responsive control. The remote control may include additional features, such as speed adjustment, steering sensitivity, and power on/off functionalities.

### 4. Safety Features:

The remote-controlled utility beach wagon is equipped with various safety features to enhance user safety during operation. These safety features may include but are not limited to:
a. Emergency Stop: A dedicated emergency stop button on the remote control that immediately halts the utility beach wagon's movement in case of emergencies.
b. Speed Limitation: Speed limitation mechanisms to prevent the utility beach wagon from exceeding safe and controllable speeds, ensuring user safety in crowded or narrow areas.
c. Battery Overload Protection: Overload protection to prevent excessive battery drain and potential damage to the motor system, ensuring longevity and safety.

### CONCLUSION

The remote-controlled utility beach wagon described herein offers an innovative and efficient solution for carrying heavy items, groceries, and various belongings in beach and outdoor environments. The integration of a small motor system and a remote control mechanism provides users with a convenient and user-friendly experience, reducing physical effort and enhancing transportation efficiency.

The patent claims and specifications define the unique aspects and novel features of this invention, offering significant utility and benefits to users seeking a reliable and practical means of transporting items in outdoor settings.

1: A utility and beach wagon comprising:
a frame structure with collapsible elements;

1: An electric motor system securely mounted on the wheels of the frame;

2: a wireless control unit for remote operation of the electric motor; and

3: a rechargeable battery system integrated into the wagon's structure.
The utility and beach wagon of claim 1, wherein the frame structure includes adjustable sides and removable racks for cargo customization.
The utility and beach wagon of claim 1, further comprising oversized, all-terrain wheels for enhanced maneuverability.
The utility and beach wagon of claim 1, wherein the wireless control unit includes an emergency stop function for safety.
